(19) United States
(12) Patent Application Publication
(10) Pub. No.: US 2011/0058884 A1
(43) Pub. Date: Mar. 10, 2011

(54) TAPE CASSETTE

(75) Inventors: Tsutomu KATO, Nagoya-shi (JP); Teruo IMAMAKI, Nagoya-shi (JP)

(73) Assignee: BROTHER KOGYO KABUSHIKI KAISHA, Nagoya-shi (JP)

(21) Appl. No.: 12/873,633

(22) Filed: Sep. 1, 2010

(30) Foreign Application Priority Data
Sep. 9, 2009 (JP) 2009-208343

(51) Int. Cl. B41J 15/00

(52) U.S. Cl. 400/613

(57) ABSTRACT

A tape cassette that includes a cassette case that includes a top case and a bottom case, a tape as a print medium that is mounted within the cassette case, an arm portion that includes a part of a front surface of the cassette case and directs the tape toward an exit along a portion of a predetermined feed path, the portion extending in parallel with the front surface, a latching portion that is provided in the vicinity of an upstream end of the arm portion in a feeding direction of the tape and by which the top case and the bottom case are engaged with each other, and a contact portion that is provided in the vicinity of the exit and that is configured to allow the top case and the bottom case to contact or separate from each other.

### CROSS-REFERENCE TO RELATED APPLICATION

This application claims priority to Japanese Patent Application No. 2009-208343 filed on Sep. 9, 2009, the disclosure of which is herein incorporated by reference in its entirety.

### BACKGROUND

The present invention relates to a tape cassette that can be detachably installed in a tape printer.

A tape cassette is known that can be detachably installed in a cassette housing portion of a tape printer. The tape cassette has an exit for discharging a print tape toward an opening at which printing is performed on the print tape. A latching piece is provided in a top case near the exit and in the front surface of the tape cassette. A latching hole is provided in a bottom case near the exit and in the front surface of the tape cassette. The latching piece and the latching hole are elastically engaged so that the top case and the bottom case are engaged.

### SUMMARY

In order to maintain good print quality, the print tape needs to be appropriately discharged from the exit. However, when the tape cassette described above drops down, for example, the engagement between the latching hole and the latching piece near the exit may be released due to a drop impact and thus a gap may be created between the top case and the bottom case near the exit. In such a case, there is a possibility that the print tape is not appropriately discharged from the exit and the print quality is deteriorated.

It is an object of the present invention to provide a tape cassette capable of restricting a gap from being created between the top case and the bottom case in the vicinity of the exit, thereby maintaining good print quality.

Various exemplary embodiments of the general principles described herein provide a tape cassette that includes a cassette case, a tape, an arm portion, a latching portion, and a contact portion. The cassette case has a top surface, a bottom surface, a front surface and a pair of side surfaces, and includes a top case having the top surface and a bottom case having the bottom surface. The tape is a print medium, and mounted within the cassette case. The arm portion includes a part of the front surface and directs the tape toward an exit along a portion of a predetermined feed path. The portion of the feed path extends in parallel with the front surface. The latching portion is provided in the vicinity of an upstream end of the arm portion in a feeding direction of the tape. The top case and the bottom case are engaged with each other by the latching portion. The contact portion is provided in the vicinity of the exit and configured to allow the top case and the bottom case to contact or separate from each other.

### BRIEF DESCRIPTION OF THE DRAWINGS

Exemplary embodiments of the present invention will be described below in detail with reference to the accompanying drawings in which:

FIG. 1 is a perspective view of a tape printer 1 as viewed from above when a cassette cover 6 is closed;

FIG. 2 is a perspective view of the tape printer 1 as viewed from above when the cassette cover 6 is opened;

FIG. 3 is a plan view of a cassette housing portion 8 with a laminated type tape cassette 30 installed, when a platen holder 12 is at a standby position;

FIG. 4 is a plan view of the cassette housing portion 8 with the laminated type tape cassette 30 installed, when the platen holder 12 is at a print position;

FIG. 5 is a perspective view of the tape cassette 30 as viewed from above;

FIG. 6 is an exploded perspective view of a cassette case 31;

FIG. 7 is a plan view of a bottom case 312;

FIG. 8 is a bottom view of a top case 311;

FIG. 9 is a front view of the tape cassette 30 for explaining how the top case 311 and the bottom case 312 are being engaged with each other;

FIG. 10 is a front view of the tape cassette 30 for explaining how the top case 311 and the bottom case 312 are completely engaged with each other;

FIG. 11 is a vertical cross-sectional view of the tape cassette 30 for explaining a latching arm 80 and a latching hole 79 while the top case 311 and the bottom case 312 are being engaged with each other;

FIG. 12 is a vertical cross-sectional view of the tape cassette 30 for explaining the latching arm 80 and the latching hole 79 when the top case 311 and the bottom case 312 are completely engaged with each other; and

FIG. 13 is a front view of the tape cassette 30 for explaining a state in which a top contact portion 86A and a bottom contact portion 86B are separated from each other in a contact portion 86.

### DETAILED DESCRIPTION OF EXEMPLARY EMBODIMENTS

An embodiment of the present invention will be described below with reference to the drawings. The drawings are used for explaining the technical features that can be employed in the present invention, and are merely exemplary.

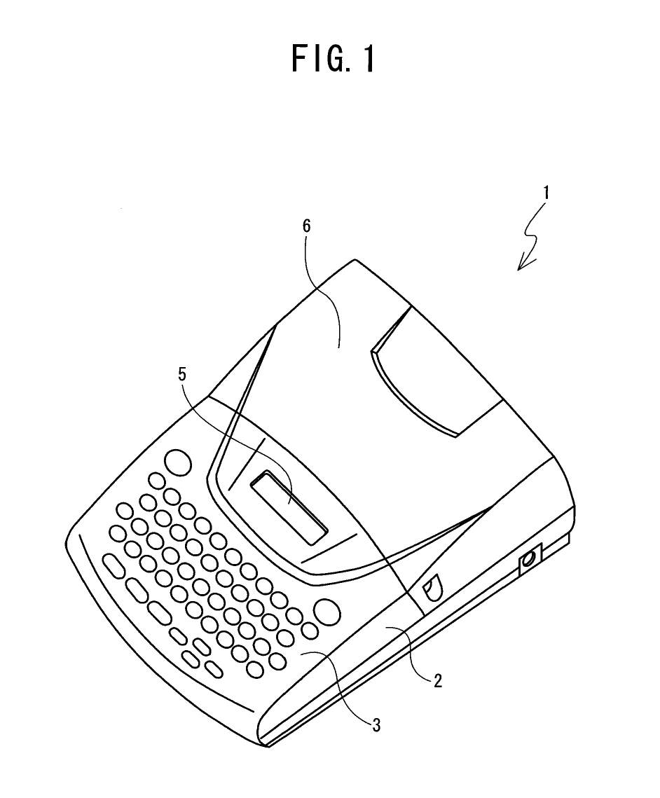

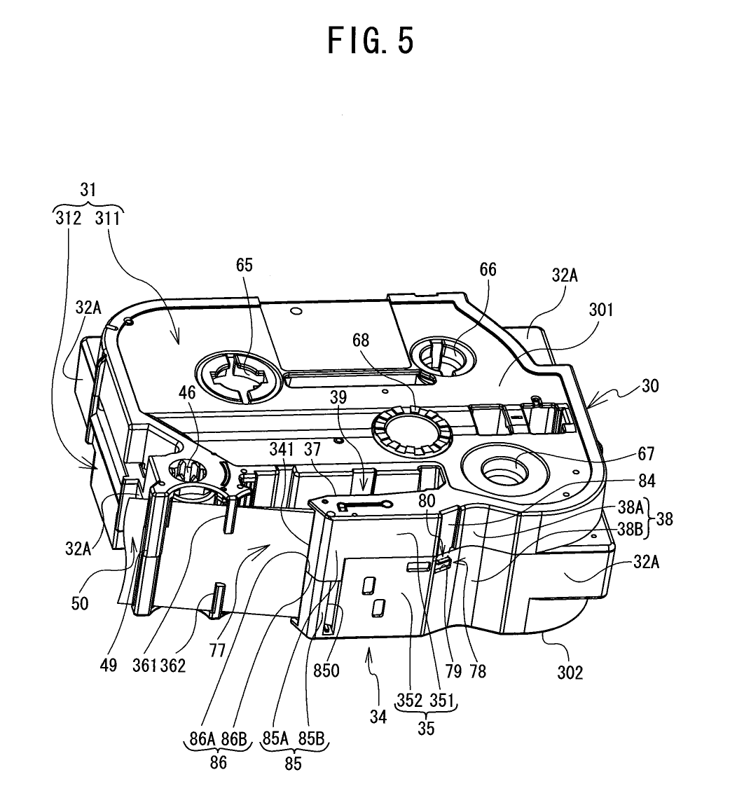

A tape printer 1 and a tape cassette 30 according to the present embodiment will be described below in detail with reference to the drawings. In the explanation of the present embodiment, the lower left side, the upper right side, the lower right side, and the upper left side in FIG. 1 are respectively defined as the front side, the rear side, the right side, and the left side of the tape printer 1. The lower front side, the upper back side, the right side, and the left side in FIG. 5 are respectively defined as the front side, the rear side, the right side, and the left side of the tape cassette 30.

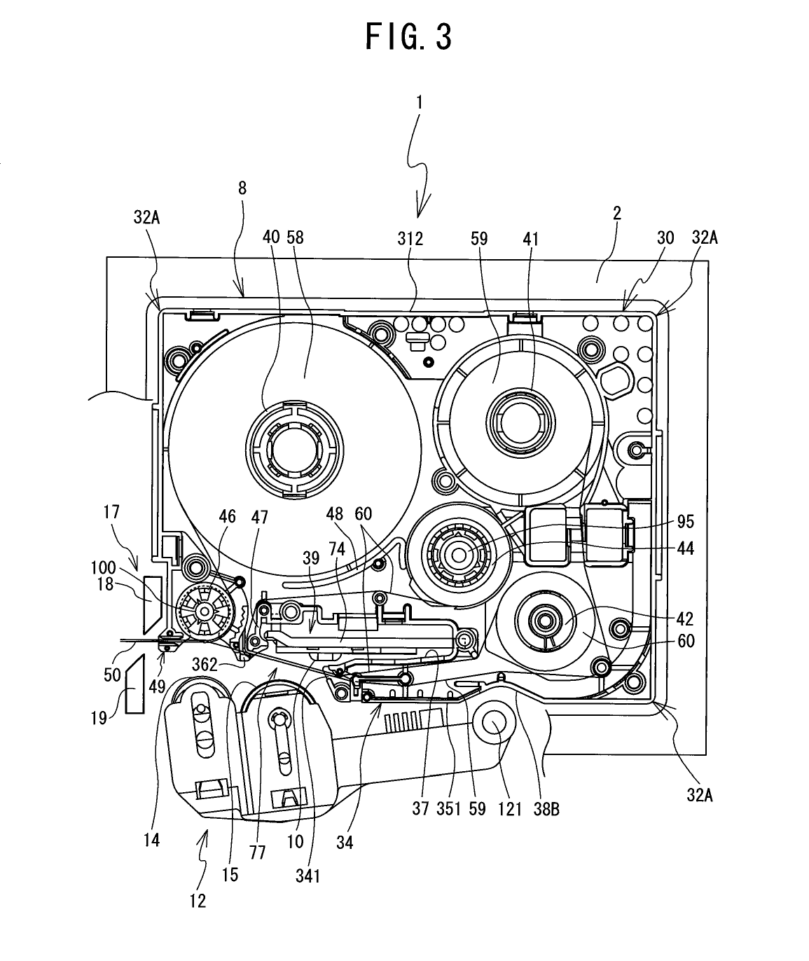

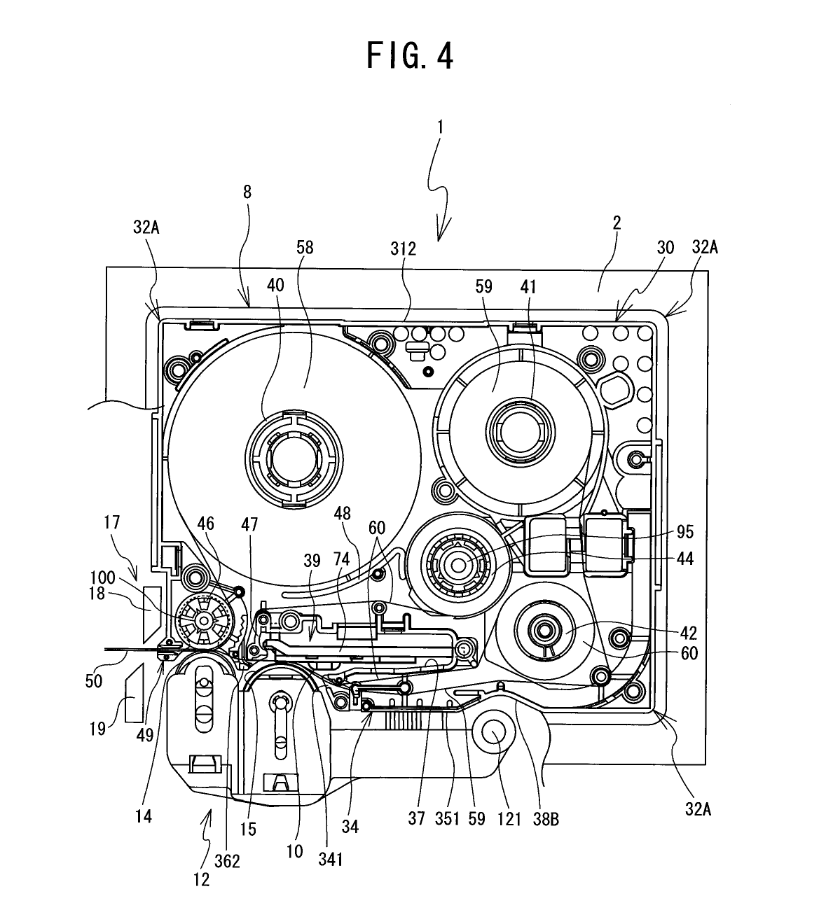

In FIGS. 3 and 4 used in the following explanation, the tape cassette 30 installed in a cassette housing portion 8 is shown with a top case 311 removed.

First, an outline configuration of the tape printer 1 according to the present embodiment will be explained. The tape printer 1 is a general purpose tape printer that can be used with various types of tape cassettes. The various types may include a heat-sensitive type, a receptor type, a laminated type, and a heat-sensitive laminated type, for example. In the present embodiment, a laminated type tape cassette for forming a laminated tape whose print surface is laminated is explained as an example of the various tape cassettes.

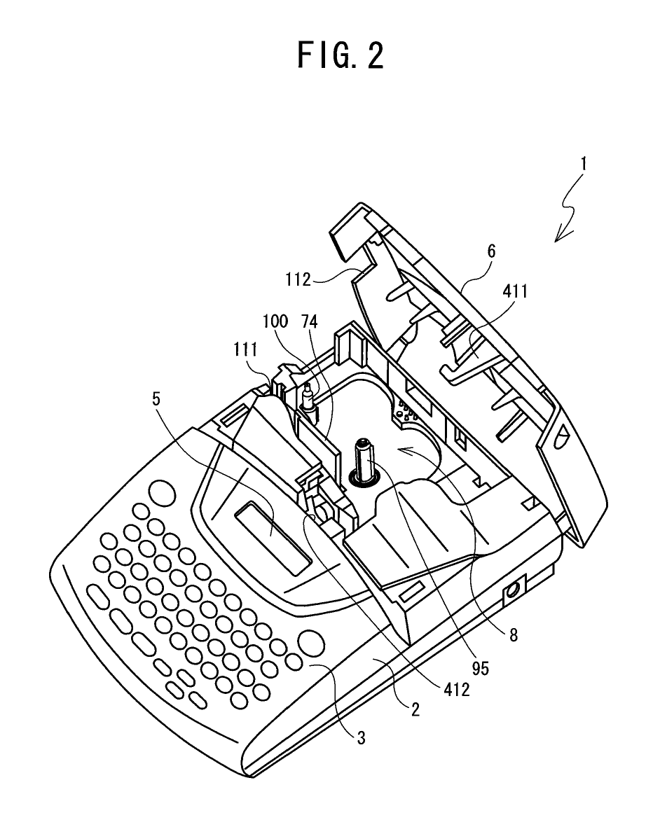

As shown in FIGS. 1 and 2, the tape printer 1 includes a main unit cover 2 that has a rectangular shape in a plan view. A keyboard 3 including character keys for characters such as letters, symbols and numerals, and a variety of function keys is arranged on the front side of the top surface of the main unit cover 2. A display 5 capable of displaying input characters is provided on the rear side of the keyboard 3. A cassette cover 6 which can be opened and closed when the tape cassette 30 (see FIG. 5) is replaced is provided on the rear side of the display 5.

A discharge slit 111 for discharging a printed tape to the outside is provided at the rear left side of the main unit cover 2. A discharge window 112 for exposing the discharge slit 111 to the outside with the cassette cover 6 closed is formed on the left side of the cassette cover 6. A hook-shaped latching lock 411 is provided substantially at the center of the front of the cassette cover 6 and protrudes downward from the bottom surface of the cassette cover 6. A lock hole 412 is provided in the main unit cover 2 at a position corresponding to the latching lock 411. When the cassette cover 6 is closed, the latching lock 411 is fitted into and engaged with the lock hole 412 so that the cassette cover 6 is prevented from unintentionally opening.

Next, an internal configuration of the main unit cover 2 below the cassette cover 6 will be explained with reference to FIGS. 2 to 4. As shown in FIG. 2, the cassette housing portion 8 is provided inside the main unit cover 2 below the cassette cover 6. The cassette housing portion 8 is an area in which or from which the tape cassette 30 (see FIG. 5) can be installed or removed. The cassette housing portion 8 is formed as a depression that substantially corresponds to the shape of a bottom surface 302 (see FIG. 5) of the cassette case 31 when the tape cassette 30 is installed.

The cassette housing portion 8 is provided with a feed mechanism for pulling out a tape from the tape cassette 30 and feeding the tape, a print mechanism for printing characters on the surface of the tape, and the like. As shown in FIGS. 2 to 4, a ribbon take-up shaft 95 for taking up a used ink ribbon 60 which has been pulled out from a ribbon spool 42 and used for printing characters is standing upward in the cassette housing portion 8. A head holder 74 that has a substantially rectangular shape in a front view is standing upward on the front left side of the ribbon take-up shaft 95. A tape drive shaft 100 for feeding the printed tape 50 is standing upward to the left of the head holder 74.

As shown in FIGS. 3 and 4, a thermal head 10 for printing characters on a film tape 59 is mounted on the front surface of the head holder 74. An arm-shaped platen holder 12 is pivotably supported about a support shaft 121 in front of the head holder 74. A platen roller 15 and a movable feed roller 14 are both rotatably supported on the leading end side of the platen holder 12. The platen roller 15 opposes the thermal head 10 and can be moved close to and apart from the thermal head 10. The movable feed roller 14 opposes a tape drive roller 46, into which the tape drive shaft 100 may be fitted, and the movable feed roller 14 can be moved close to and apart from the tape drive roller 46.

A release lever (not shown) is coupled to the platen holder 12. The release lever moves in the horizontal direction along with the opening/closing of the cassette cover 6. When the cassette cover 6 is opened, the release lever moves in the right direction and the platen holder 12 moves toward a standby position shown in FIG. 3. At the standby position shown in FIG. 3, the platen holder 12 has moved away from the cassette housing portion 8 and thus the tape cassette 30 can be installed in or removed from the cassette housing portion 8. The platen holder 12 is constantly elastically urged to remain in the standby position by a spiral spring (not shown).

On the other hand, when the cassette cover 6 is closed, the release lever is moved in the left direction and the platen holder 12 moves toward a print position shown in FIG. 4. At the print position shown in FIG. 4, the platen holder 12 has moved in the direction to be close to the cassette housing portion 8. When the tape cassette 30 is installed in the cassette housing portion 8, the platen roller 15 presses the thermal head 10 via the film tape 59 and the ink ribbon 60. At the same time, the movable feed roller 14 presses the tape drive roller 46 via a double-sided adhesive tape 58 and the film tape 59. Thus, at the print position shown in FIG. 4, printing can be performed using the tape cassette 30 installed in the cassette housing portion 8. The double-sided adhesive tape 58, the film tape 59 and the ink ribbon 60 will be explained in more detail later.

As shown in FIGS. 3 and 4, a feed path along which the printed tape 50 is fed extends from a tape discharge portion 49 of the tape cassette 30 to the discharge slit 111 (see FIG. 2) of the tape printer 1. A cutting mechanism 17 that cuts the printed tape 50 at a predetermined position is provided on the feed path. The cutting mechanism 17 includes a fixed blade 18 and a movable blade 19. The movable blade 19 opposes the fixed blade 18 and is movably supported. The movable blade 19 is moved in the back-and-forth direction (in the vertical direction shown in FIG. 3) by a cutter motor (not shown).

The configuration of the tape cassette 30 according to the present embodiment will be explained below with reference to FIGS. 3 to 6. In the present embodiment, the tape cassette 30 is a laminated type tape cassette configured from a general purpose tape cassette, which can be assembled as each type of the above various tape cassettes.

As shown in FIG. 5, the tape cassette 30 includes the cassette case 31. The cassette case 31 is a housing having a generally rectangular parallelepiped shape (box-like shape), with rounded corner portions in a plan view. The cassette case 31 includes the top case 311 and a bottom case 312. The bottom case 312 includes the bottom surface 302 of the cassette case 31. The top case 311 includes a top surface 301 of the cassette case 31 and is joined to an upper portion of the bottom case 312. A distance from the bottom surface 302 to the top surface 301 is referred to as a height of the tape cassette 30 or a height of the cassette case 31.

The cassette case 31 has four corner portions 32A that have the same width (the same length in the vertical direction) regardless of a tape type (such as a tape width or a print mode) of the tape cassette 30. The corner portions 32A each protrude in an outward direction to form a right angle when seen in a plan view. However, the front left corner portion 32A does not form a right angle in the plan view as the tape discharge portion 49 is provided in the corner.

The cassette case 31 has support holes 65, 66, 67 and 68 for rotatably supporting a first tape spool 40, a second tape spool 41, a ribbon spool 42 and a ribbon take-up spool 44 described below (see FIGS. 3 and 4), respectively. Although only the support holes 65, 66, 67 and 68 of the top case 311 are shown in FIG. 5, the corresponding support holes 65, 66, 67 and 68 are provided in the bottom case 312.

As shown in FIGS. 3 and 4, the double-sided adhesive tape 58 wound on the first tape spool 40, the transparent film tape 59 wound on the second tape spool 41 and the ink ribbon 60 wound on the ribbon spool 42 are mounted in the cassette case 31. The double-sided adhesive tape 58 is a double-sided tape with a release paper affixed to one of its surfaces, and is wound on the first tape spool 40 with the release paper facing outwards. The other surface of the double-sided adhesive tape 58 can be affixed to the print surface of the film tape 59 that has been used for printing.

The first tape spool 40 is rotatably supported by the support holes 65 in the rear left portion within the cassette case 31. The second tape spool 41 is rotatably supported by the support holes 66 in the rear right portion within the cassette case 31. The ribbon spool 42 is rotatably supported by the support holes 67 in the front right portion within the cassette case 31.

The ribbon take-up spool 44 is rotatably supported by the support holes 68 between the first tape spool 40 and the ribbon spool 42 within the cassette case 31. The ribbon take-up spool 44 pulls out the ink ribbon 60 from the ribbon spool 42 and takes up the used ink ribbon 60 that has been used for printing characters. A clutch spring (not shown) is attached to a lower portion of the ribbon take-up spool 44 to prevent loosening of the taken-up ink ribbon 60 due to a reverse rotation of the ribbon take-up spool 44.

As shown in FIG. 5, a semi-circular groove 38 is provided in a front surface of the cassette case 31 and extends in the height direction of the cassette case 31 (that is, from the top surface 301 to the bottom surface 302). The semi-circular groove 38 has a substantially semi-circular shape in a plan view. Of the semi-circular groove 38, a portion formed in the top case 311 is referred to as a top semi-circular groove 38A and a portion formed in the bottom case 312 is referred to as a bottom semi-circular groove 38B. Thus the semi-circular groove 38 is formed by the top semi-circular groove 38A and the bottom semi-circular groove 38B. The semi-circular groove 38 is a portion that serves to prevent interference between the support shaft 121 (see FIG. 3) of the platen holder 12 and the cassette case 31 when the tape cassette 30 is installed in the cassette housing portion 8.

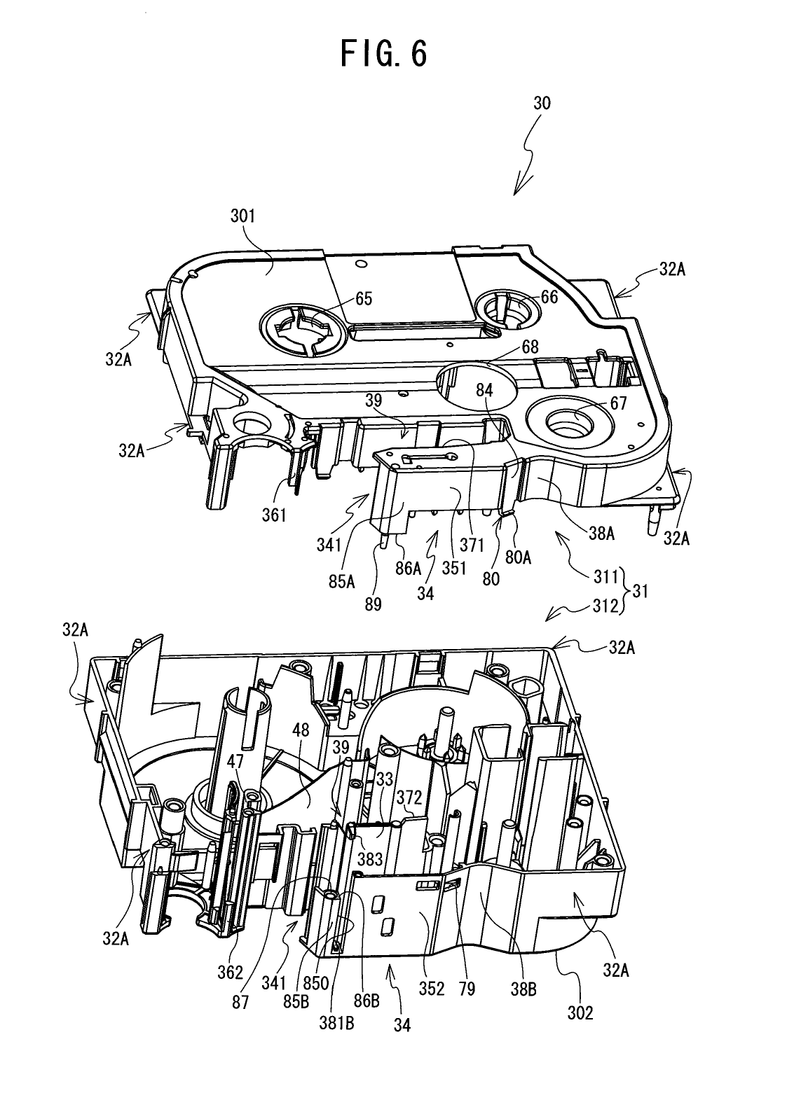

The semi-circular groove 38 is provided with a latching portion 78. The latching portion 78 is a portion where the top case 311 and the bottom case 312 are engaged with each other. The latching portion 78 includes a latching hole 79 and a latching arm 80. The latching hole 79 is provided in the bottom case 312. The latching arm 80 is provided in the top case 311 and includes a latching claw 80A (see FIG. 6). The latching portion 78 will be explained in more detail later.

As shown in FIG. 5, of the front surface of the cassette case 31, a section extending leftward from the semi-circular groove 38 is referred to as an arm front surface 35. A portion that extends leftward from the right side of the tape cassette 30 and that is defined by the arm front surface 35 and an arm rear surface 37, which is separately provided at the rear of the arm front surface 35 and extends in the height direction of the cassette case 31, is referred to as an arm portion 34.

Of the arm front surface 35, a portion formed in the top case 311 is referred to as a top arm front surface 351 and a portion formed in the bottom case 312 is referred to as a bottom arm front surface 352. Of the arm rear surface 37, a portion formed in the top case 311 is referred to as a top arm rear surface 371 (see FIG. 6) and a portion formed in the bottom case 312 is referred to as a bottom arm rear surface 372 (sec FIG. 6).

The left end portion of the arm front surface 35 is referred to as an arm leading end portion 85. The arm leading end portion 85 is adjacent to an exit 341. Of the arm leading end portion 85, a portion formed in the top case 311 is referred to as a top leading end portion 85A and a portion formed in the bottom case 312 is referred to as a bottom leading end portion 85B. More specifically, the bottom leading end portion 85B is on the left side of a die exit hole 850, which will be described later, in the bottom arm front surface 352. The top leading end portion 85A is a portion of the top arm front surface 351 that can be connected to the upper side of the bottom leading end portion 85B.

As shown in FIGS. 3 and 4, the film tape 59 pulled out from the second tape spool 41 and the ink ribbon 60 pulled out from the ribbon spool 42 are both guided in the arm portion 34. The arm leading end portion 85 is bent rearwards, and the exit 341 is formed by the arm leading end portion 85 and the leading end of the arm rear surface 37. The film tape 59 and the ink ribbon 60 that are layered at the exit 341 are discharged toward an opening 77.

A head insertion portion 39 is a space that is defined by the arm rear surface 37 and a peripheral wall that extends continuously from the arm rear surface 37. The head insertion portion 39 has a substantially rectangular shape in a plan view, and extends through the tape cassette 30 in the vertical direction. The head insertion portion 39 is also connected to the outside on the front surface side of the tape cassette 30 through the opening 77 provided on the front surface side of the tape cassette 30. The head holder 74 supporting the thermal head 10 may be inserted into the head insertion portion 39. One of the surfaces of the film tape 59 discharged from the exit 341 of the arm portion 34 is exposed toward the front at the opening 77. The other surface of the film tape 59 opposes the thermal head 10 disposed behind, across the ink ribbon 60. Printing on the film tape 59 is performed by the thermal head 10 at the opening 77 by using the ink ribbon 60.

As shown in FIGS. 3 and 4, the tape drive roller 46 is rotatably supported on a downstream side of the head insertion portion 39 in a feeding direction of the film tape 59 and the ink ribbon 60 from the exit 341 of the arm portion 34 to the tape discharge portion 49. The tape drive roller 46 is driven to rotate by the tape drive shaft 100 inserted therein. The tape drive roller 46 pulls out the film tape 59 from the second tape spool 41 in concert with the movable feed roller 14 of the platen holder 12 opposing the tape drive roller 46. At the same time, the tape drive roller 46 also pulls out the double-sided adhesive tape 58 from the first tape spool 40, and guides it to the print surface of the film tape 59 to bond them together.

As shown in FIGS. 3 to 5, a pair of top and bottom regulating members 361 and 362 is provided on the upstream side of the tape drive roller 46. Base portions of the regulating members 361 and 362 regulate the film tape 59, on which printing has been performed, in the vertical direction (in the tape width direction) on the downstream side of the thermal head 10, and direct the film tape 59 toward the tape discharge portion 49. The regulating members 361 and 362 appropriately bond the film tape 59 and the double-sided adhesive tape 58 together without making any positional displacement therebetween.

A guide wall 47 is standing in the vicinity of the regulating members 361 and 362. The guide wall 47 separates the used ink ribbon 60 which has been fed via the head insertion portion 39 from the film tape 59, and directs the ink ribbon 60 toward the ribbon take-up spool 44. A second separating wall 48 is standing between the guide wall 47 and the ribbon take-up spool 44. The second separating wall 48 prevents a contact between the used ink ribbon 60 directed along the guide wall 47 and the double-sided adhesive tape 58 supported by and wound on the first tape spool 40.

When printing is being performed in the tape printer 1, the tape drive roller 46 that is driven to rotate by the tape drive shaft 100 pulls out the film tape 59 from the second tape spool 41 in concert with the movable feed roller 14. The ribbon take-up spool 44 that is driven to rotate by the ribbon take-up shaft 95 pulls out the unused ink ribbon 60 from the ribbon spool 42 in synchronization with the print speed. The film tape 59 pulled out from the second tape spool 41 passes along the outer edge of the ribbon spool 42 and then is fed along the feed path within the arm portion 34. Then, the film tape 59 is supplied from the exit 341 toward the head insertion portion 39 in a state where the ink ribbon 60 is layered on the surface of the film tape 59, to be fed between the thermal head 10 and the platen roller 15.

Characters are printed on the print surface of the film tape 59 by the thermal head 10. Thereafter, the used ink ribbon 60 is separated from the printed film tape 59 at the guide wall 47, and then is wound onto the ribbon take-up spool 44. In the meantime, the double-sided adhesive tape 58 is pulled out from the first tape spool 40 by the tape drive roller 46 and the movable feed roller 14 working in concert. While being guided and caught between the tape drive roller 46 and the movable feed roller 14, the double-sided adhesive tape 58 is layered onto and affixed to the print surface of the printed film tape 59. The printed film tape 59 to which the double-sided adhesive tape 58 is affixed (that is, the printed tape 50) is further fed toward the tape discharge portion 49, is discharged from the tape discharge portion 49, and then is cut by the cutting mechanism 17.

In the present embodiment, the laminated type tape cassette 30 assembled from the general purpose cassette is used in the general purpose tape printer 1. Thus, a single tape printer 1 can be used to correspond with each type of the tape cassette such as the heat-sensitive type, receptor type, laminated type and heat-sensitive laminated type. Therefore, it is not necessary to use a different tape printer for each type.

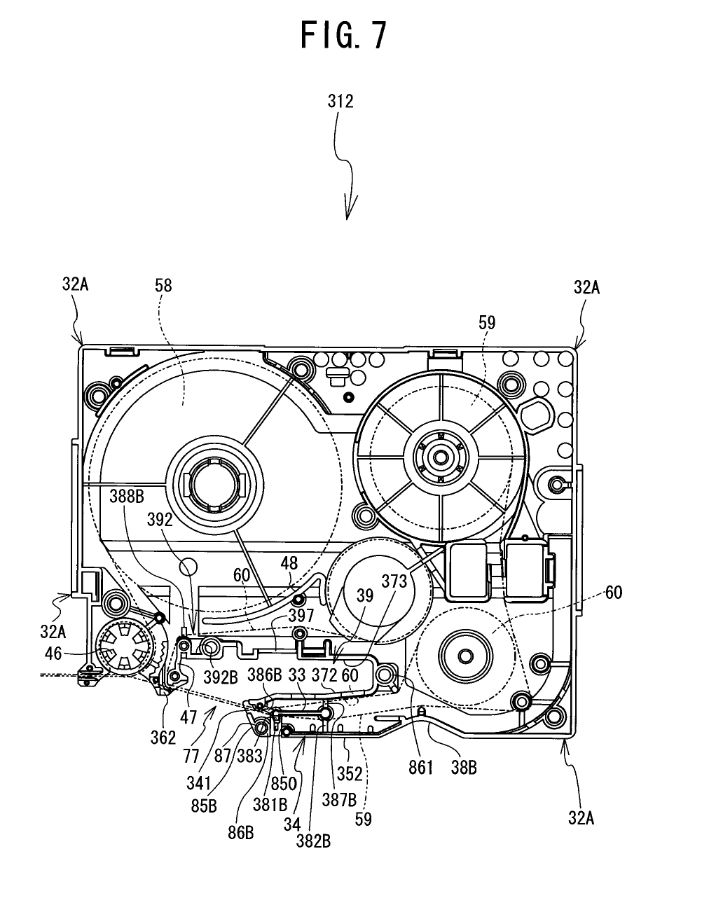

Next, a section of the bottom case 312 that forms a part of the arm portion 34 will be explained in detail with reference to FIGS. 6 and 7. As shown in FIGS. 6 and 7, the section of the bottom case 312 included in the arm portion 34 include the bottom arm front surface 352, the bottom arm rear surface 372 and a first separating wall 33 provided therebetween. The die exit hole 850 is provided on the right side of the bending portion in the left end portion of the bottom arm front surface 352. The die exit hole 850 is a cutout in the upright rectangular shape in a front view, and is formed in the bottom arm front surface 352 from its top edge. When the top case 311 is joined with the bottom case 312, the die exit hole 850 forms a through-hole in the arm front surface 35 (see FIG. 5).

The first separating wall 33 is formed to be the highest among the three walls of the arm portion 34, with its height slightly larger than the width of the tape to be housed within the cassette case 31. The bottom leading end portion 85B, which is a section of the bottom arm front surface 352 on the left side of the die exit hole 850, is substantially half as high as the first separating wall 33. A section of the bottom arm front surface 352 on the right side of the die exit hole 850 is about two thirds as high as the first separating wall 33. The bottom arm rear surface 372 is slightly lower than the first separating wall 33 and has substantially the same height as the width of the ink ribbon 60. The right end portion, which is cylindrically-shaped in a plan view, of the first separating wall 33 is positioned substantially at the center of the arm portion 34. The left end of the first separating wall 33 is opposite to the die exit hole 850 provided in the bottom arm front surface 352 in the back-and-forth direction of the bottom case 312. The die exit hole 850 is an exit hole for a die that is used in manufacturing the bottom case 312.

As shown in FIG. 7, the feed path of the film tape 59 is formed between the bottom arm front surface 352 and the first separating wall 33. On the other hand, the feed path of the ink ribbon 60 is formed between the first separating wall 33 and the bottom arm rear surface 372. Therefore, regulating pieces for regulating a movement of the tape or the ink ribbon 60 in the width direction (in the vertical direction of the cassette case 31) are provided on the feed paths.

For the feed path of the film tape 59, first tape bottom regulating portions 381B and 382B for regulating the movement of the film tape 59 in the downward direction are provided at the bottom ends of the right and left ends of the first separating wall 33, respectively. The first tape bottom regulating portions 381B and 382B slightly protrude upward from the bottom surface 302. The first tape bottom regulating portions 381B and 382B extend forward from the first separating wall 33 to the bottom arm front surface 352, respectively. A separating wall regulating portion 383 for regulating the movement of the film tape 59 in the upward direction is provided at the upper end of the left end of the first separating wall 33. The separating wall regulating portion 383 is a protruding piece which protrudes forward from the upper end of the first separating wall 33. The distance in the vertical direction between the first tape bottom regulating portions 381B, 382B and the separating wall regulating portion 383 is the same as the width of the film tape 59.

For the feed path of the ink ribbon 60, first ribbon bottom regulating portions 386B and 387B for regulating a movement of the ink ribbon 60 in the downward direction are provided at the bottom ends of the right and left ends of the first separating wall 33, respectively. The first ribbon bottom regulating portions 386B and 3878 slightly protrude upward from the bottom surface 302. The first ribbon bottom regulating portion 386B extends diagonally backward left from the left end of the first separating wall 33 to the left end of the bottom arm rear surface 372. The first ribbon bottom regulating portion 387B extends backward from the right end of the first separating wall 33 to the bottom arm rear surface 372.

The positions in the vertical direction of the protruding ends of the first tape bottom regulating portions 381E and 382B are set depending on the width of the film tape 59. The positions in the vertical direction of the protruding ends of the first ribbon bottom regulating portions 386B and 3878 are set depending on the width of the ink ribbon 60.

The first tape bottom regulating portions 381B and 382B regulate the movement of the film tape 59 in the downward direction, and the first ribbon bottom regulating portions 386B and 387B regulate the movement of the ink ribbon 60 in the downward direction. Therefore, the feeding accuracy of the film tape 59 and the ink ribbon 60 may be enhanced. Since the arm portion 34 is in the vicinity of the upstream side of a printing position (the opening 77) where printing is performed by the thermal head 10 (see FIG. 3), the feeding accuracy of the tape and the ink ribbon 60 inside the arm portion 34 may be enhanced and thus the printing accuracy may also be improved.

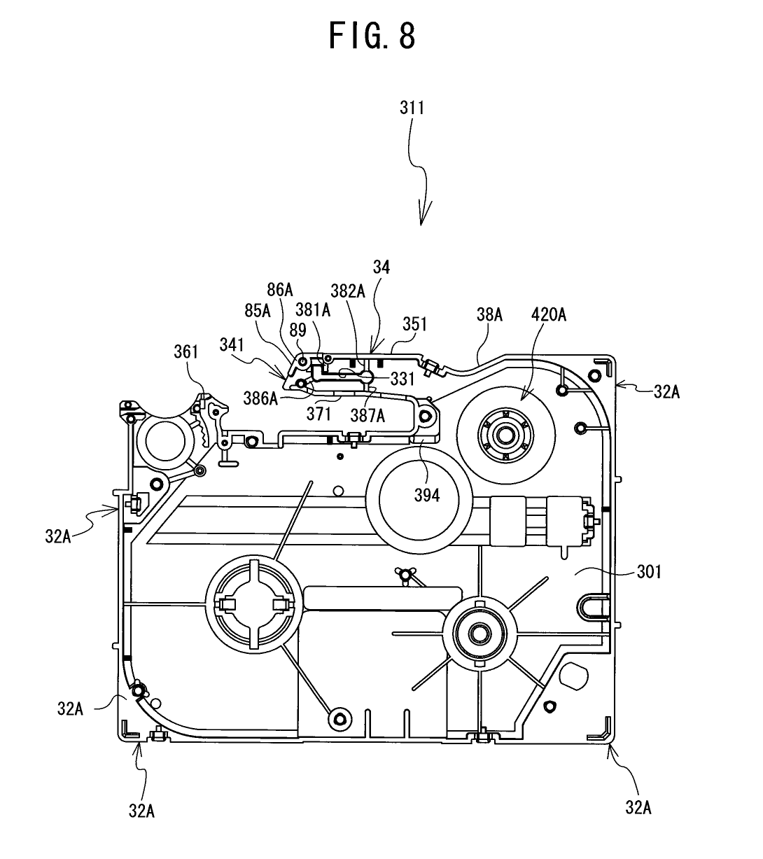

Next, a section of the top case 311 that forms a part of the arm portion 34 will be explained in detail with reference to FIGS. 6 and 8. As shown in FIGS. 6 and 8, the section of the top case 311 included in the arm portion 34 include the top arm front surface 351 and the top arm rear surface 371 corresponding to the bottom arm front surface 352 and the bottom arm rear surface 372 of the bottom case 312, respectively. Thus, the top arm front surface 351 is higher than the top arm rear surface 371. The top surface 301 is provided with a fit hole 331 at a position that corresponds to the first separating wall 33 provided inside the arm portion 34 of the bottom case 312. The fit hole 331 has substantially the same shape as the shape of the first separating wall 33 in a plan view. When the top case 311 and the bottom case 312 are joined with each other, the first separating wall 33 is fitted into the fit hole 331.

In the section of the top case 311 that forms a part of the arm portion 34, the feed path of the tape is provided between the top arm front surface 351 and the fit hole 331. The feed path of the ink ribbon 60 is provided between the fit hole 331 and the top arm rear surface 371. Thus, regulating pieces for regulating the movement of the tape or the ink ribbon 60 in the upward direction are provided on these feed paths similarly to the bottom case 312.

For the feed path of the tape, a first tape top regulating portion 381A is provided on the right side of the left end of the fit hole 331. A first tape top regulating portion 382A is provided adjacent to the right end of the fit hole 331. The first tape top regulating portions 381A and 382A slightly protrude downward from the top surface 301, respectively. The first tape top regulating portion 381A extends backward from the top arm front surface 351 to just before the fit hole 331, and the first tape top regulating portion 382A extends backward from the top arm front surface 351 to the fit hole 331. The first tape top regulating portions 381A and 382A regulate the movement of the film tape 59 in the upward direction, respectively.

For the feed path of the ink ribbon 60, first ribbon top regulating portions 386A and 387A for regulating the movement of the ink ribbon 60 in the upward direction are provided adjacent to the left end and the right end of the fit hole 331, respectively. The first ribbon top regulating portions 386A and 387A slightly protrude downward from the top surface 301, respectively. The first ribbon top regulating portion 386A extends diagonally backward left from the left end of the fit hole 331 to the left end of the top arm rear surface 371. The first ribbon top regulating portion 387A extends diagonally backward left from the right end of the fit hole 331 to the top arm rear surface 371.

The positions in the vertical direction of the protruding ends of the first tape top regulating portions 381A and 382A are set depending on the width of the tape. The positions in the vertical direction of the protruding ends of the first ribbon top regulating portions 386A and 387A are set depending on the width of the ink ribbon 60.

The first tape top regulating portions 381A and 382A regulate the movement of the film tape 59 in the upward direction, and the first ribbon top regulating portions 386A and 387A regulate the movement of the ink ribbon 60 in the upward direction. Therefore, the feeding accuracy of the film tape 59 and the ink ribbon 60 may be enhanced. Thus, the printing accuracy may also be improved.

In this way, in the present embodiment, the regulating portions are provided not only in the bottom case 312 but also in the top case 311, and thus the movements of the tape and the ink ribbon 60 both in the downward and upward directions may be regulated. Consequently, the feeding accuracy and the printing accuracy may be improved.

Next, the arm leading end portion 85 and the contact portion 86 will be explained with reference to FIGS. 5 and 6. As described above, the arm leading end portion 85 includes the top leading end portion 85A provided in the top arm front surface 351 and the bottom leading end portion 85B provided in the bottom arm front surface 352.

As shown in FIG. 5, while the top case 311 and the bottom case 312 are joined with each other, the bottom end of the top leading end portion 85A and the top end of the bottom leading end portion 85B contact each other substantially at the center of the tape cassette 30 in its height direction. The bottom end of the top leading end portion 85A is referred to as a top contact portion 86A. The top end of the bottom leading end portion 85B is referred to as a bottom contact portion 86B. As will be explained later in detail, the tape cassette 30 is configured such that the top contact portion 86A and the bottom contact portion 86B can contact or separate from each other. Thus, the contact portion 86 is a section that includes the top contact portion 86A and the bottom contact portion 86B and in which the top case 311 and the bottom case 312 can contact or separate from each other.

As shown in FIG. 6, the bottom leading end portion 85B has a leading end aperture 87 extending in the vertical direction. The leading end aperture 87 is a through-hole penetrating through the bottom surface 302 of the tape cassette 30, and is formed to be circular in a plan view. The leading end aperture 87 may be formed as a hole that does not penetrate through the bottom surface 302 of the tape cassette 30. The diameter of the upper portion of the leading end aperture 87 is gradually larger toward its top end, such that the opening diameter of the top end is maximum. Thus, a protruding portion 89 can be easily inserted into the leading end aperture 87.

As shown in FIG. 6, the top case 311 is provided with the protruding portion 89 protruding downward from the top contact portion 86A. The protruding portion 89 is substantially cylindrical and the diameter of the protruding portion 89 is smaller than the diameter of the leading end aperture 87. The protruding portion 89 is formed such that its diameter is gradually smaller toward the leading end (bottom end) from the slightly upper side of the center in the vertical direction. In other words, the lower portion of the protruding portion 89 is formed such that its leading end is tapered. Thus, the protruding portion 89 can be easily inserted into the leading end aperture 87.

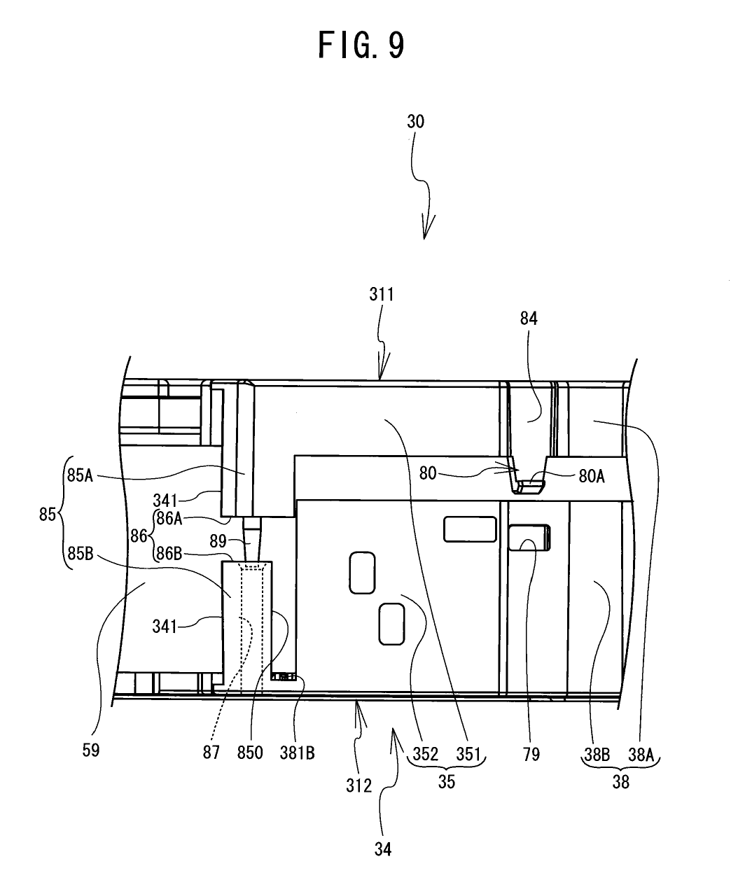

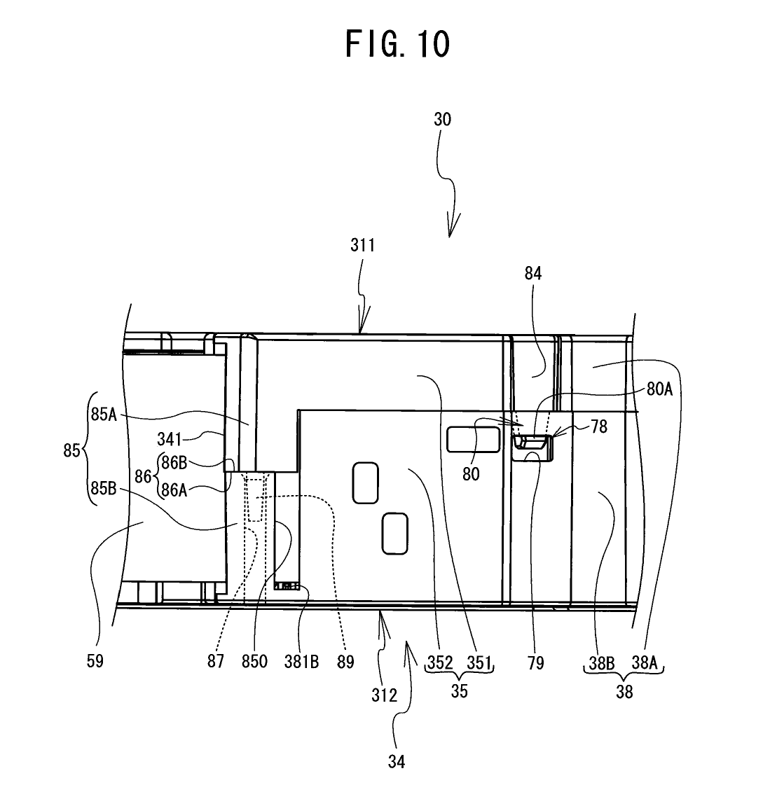

Next, a process in which the protruding portion 89 is inserted into the leading end aperture 87 to form the contact portion 86 when the top case 311 and the bottom case 312 are joined with each other will be explained with reference to FIGS. 9 and 10. When the top case 311 and the bottom case 312 are joined with each other, the bottom end of the protruding portion 89 is first inserted into the leading end aperture 87 as shown in FIG. 9. As described above, the diameter of the protruding portion 89 is smaller than the diameter of the leading end aperture 87. The lower portion of the protruding portion 89 is formed such that its leading end is tapered, and the top end of the leading end aperture 87 is formed such that its opening is wider. Thus, the bottom of the protruding portion 89 may be guided into the leading end aperture 87 smoothly.

When the protruding portion 89 is further inserted into the leading end aperture 87, the top contact portion 86A and the bottom contact portion 86B contact each other as shown in FIG. 10. Thus, the insertion of the protruding portion 89 into the leading end aperture 87 is completed. Since the diameter of the protruding portion 89 is smaller than the diameter of the leading end aperture 87, the top case 311 and the bottom case 312 are not fixed to each other in the arm leading end portion 85. In other words, the protruding portion 89 can still be inserted into or removed from the leading end aperture 87. Thus, the top contact portion 86A and the bottom contact portion 86B can contact or separate from each other in the contact portion 86.

Next, the configuration of the latching arm 80 will be explained with reference to FIGS. 6 and 9. As shown in FIGS. 6 and 9, an indented portion 84 is provided in the left portion of the top semi-circular groove 38A of the top case 311. The indented portion 84 extends from the top end to the bottom end of the top semi-circular groove 38A. The depth of the indented portion 84 is substantially the same as the thickness of a wall forming the bottom semi-circular groove 38B of the bottom case 312. The latching arm 80 protrudes downward from the bottom end of the indented portion 84. The latching arm 80 is substantially prismatic. The latching arm 80 has the latching claw 80A at its leading end (bottom end). The latching claw 80A protrudes diagonally forward right of the tape cassette 30. In this way, the latching arm 80 is formed like a hook, integral with the latching claw 80A. The latching arm 80 is flexible diagonally in the back-and-forth direction of the tape cassette 30. Thus, the latching arm 80 may be bent toward the rear surface side of the latching arm 80.

The latching hole 79 is provided in the left portion of the bottom semi-circular groove 38B of the bottom case 312 and slightly below the top end of the bottom semi-circular groove 38B. The latching hole 79 is a rectangular through-hole that is long in the right-and-left direction in a front view. The latching claw 80A provided in the latching arm 80 of the top case 311 can be engaged with the latching hole 79. Thus, the bottom case 312 and the top case 311 can be engaged with each other. The latching hole 79 is larger than the latching claw 80A in a front view.

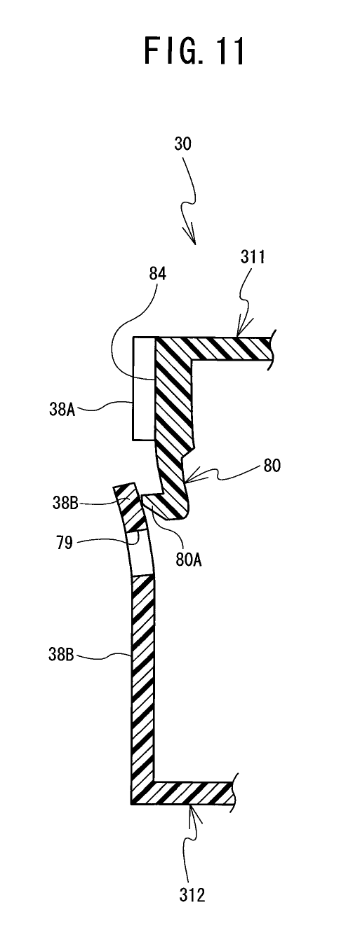

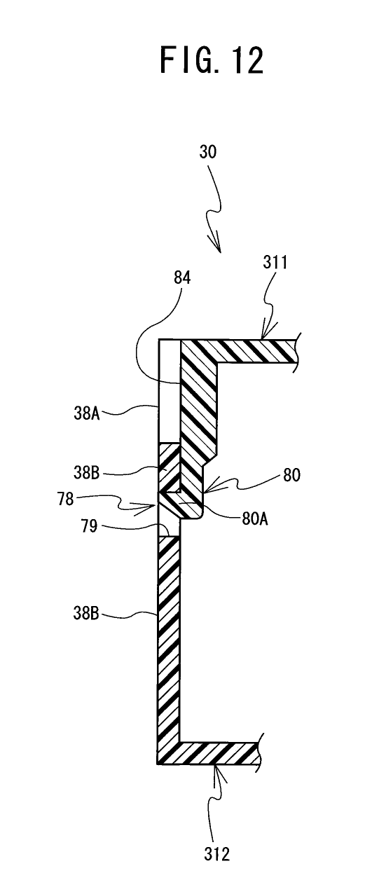

Explanation will be given on the engagement between the latching hole 79 and the latching claw 80A when the top case 311 and the bottom case 312 are joined with each other, with reference to FIGS. 11 and 12. As described above, the latching arm 80 is formed such that the latching arm 80 can be bent toward the rear surface side of the latching arm 80 (in the right direction in FIG. 11). As shown in FIG. 11, when the bottom case 312 and the top case 311 are engaged with each other, the front end of the latching claw 80A moves in the downward direction while contacting the rear surface of the bottom semi-circular groove 38B. At this time, since the front end of the latching claw 80A is pressed toward the rear surface side of the latching arm 80 by the rear surface of the bottom semi-circular groove 38B, the latching arm 80 is bent toward the rear surface side of the latching arm 80. At the same time, the bottom semi-circular groove 38B is pressed in the front right direction (in the left direction in FIG. 11) of the tape cassette 30 by the front end of the latching claw 80A, and thus the bottom semi-circular groove 38B is bent in the front right direction.

Then, when the latching claw 80A reaches the latching hole 79, as shown in FIG. 12, the latching claw 80A is inserted into the latching hole 79 so that the bottom case 312 and the top case 311 are engaged with each other. Thus, the latching portion 78 is formed. The latching portion 78 is formed in the left portion of the semi-circular groove 38, that is, in the vicinity of the upstream end of the arm portion 34 in the tape feeding direction. While the latching claw 80A is being inserted into the latching hole 79, neither the latching arm 80 nor the bottom semi-circular groove 38B is bent. At this time, the latching claw 80A contacts the top surface of the latching hole 79. Therefore, even when an impact is given to the tape cassette 30, for example, the top case 311 and the bottom case 312 can be prevented from separating from each other in the vertical direction.

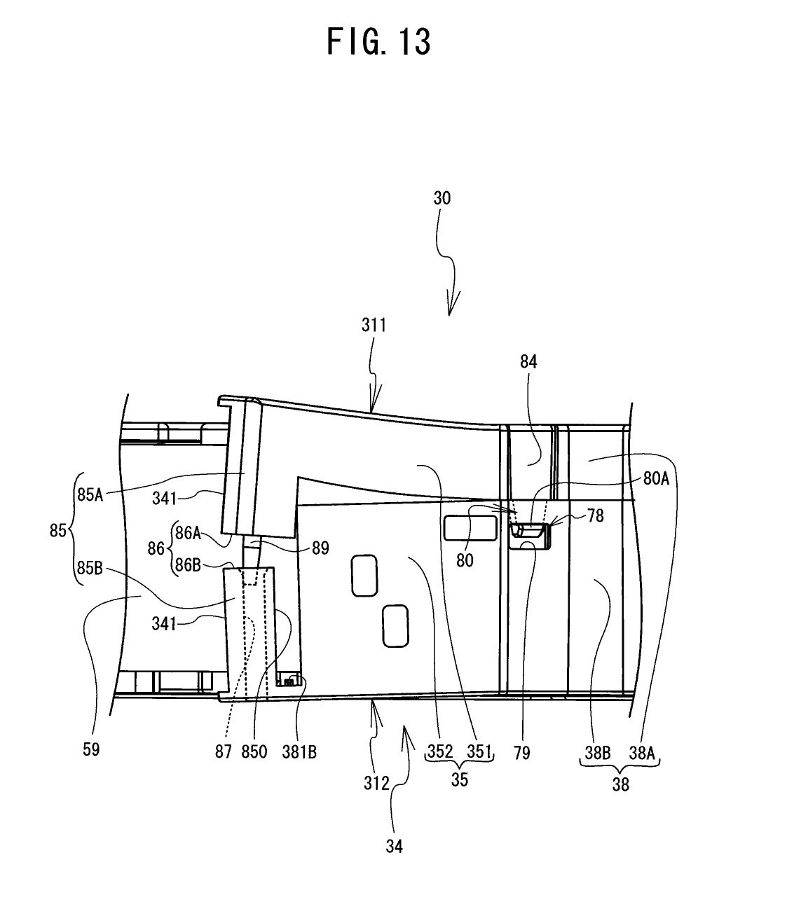

Next, with reference to FIGS. 10 and 13, explanation will be given on a case in which an impact is given to the tape cassette 30, for example, and a force is applied to the arm portion 34 in the vertical direction of the tape cassette 30. FIG. 10 shows a state in which the top contact portion 86A and the bottom contact portion 86B are in contact with each other. In the following explanation, a state of the tape cassette 30 shown in FIG. 10 is referred to as a “normal state”. When the force is applied to the arm portion 34 in the vertical direction of the tape cassette 30, the state of the tape cassette 30 may be changed from the normal state shown in FIG. 10 to a state in which the top contact portion 86A and the bottom contact portion 86B are separated from each other as shown in FIG. 13. In the following explanation, the state of the tape cassette 30 shown in FIG. 13 is referred to as “separated state”.

As shown in FIGS. 10 and 13, the top case 311 and the bottom case 312 are not fixed to each other in the arm leading end portion 85. Specifically, the top contact portion 86A and the bottom contact portion 86B can contact or separate from each other in the contact portion 86. On the other hand, the top case 311 and the bottom case 312 are prevented from separating from each other in the vertical direction in the latching portion 78.

Consequently, when the vertical force is applied to the arm portion 34 in the vertical direction, as shown in FIG. 13, the top case 311 and the bottom case 312 can remain engaged with each other in the latching portion 78, while the top case 311 and the bottom case 312 may be bent in the vertical direction in the arm portion 34 that is on the left side of the latching portion 78. Thus, the top contact portion 86A and the bottom contact portion 86B may separate from each other.

However, since the top case 311 and the bottom case 312 remain engaged in the latching portion 78, the top contact portion 86A and the bottom contact portion 86B, even when they have been separated from each other, again contact each other by a restoring force of the top case 311 and the bottom case 312. Thus, the tape cassette 30 returns to the normal state as shown in FIG. 10. In other words, even when an impact is applied to the tape cassette 30 and the vertical force is applied to the arm portion 34, the state of the arm leading end portion 85 can be restored to the normal state.

In addition, even when the top contact portion 86A and the bottom contact portion 86B separate from each other (see FIG. 13), the first tape bottom regulating portions 381B, 382B, the separating wall regulating portion 383, the first ribbon bottom regulating portions 386B, 387B, the first tape top regulating portions 381A, 382A, and the first ribbon top regulating portions 386A, 387A can regulate the vertical positions of the film tape 59 and the ink ribbon 60 to a certain extent. Thus, the positions of the film tape 59 and the ink ribbon 60 may not be largely moved. Consequently, when the tape cassette 30 returns from the separated state shown in FIG. 13 to the normal state shown in FIG. 10, the positions of the film tape 59 and the ink ribbon 60 can remain unchanged. In other words, when the tape cassette 30 returns to the normal state, the first tape bottom regulating portions 381B, 382B, the separating wall regulating portion 383, the first ribbon bottom regulating portions 386B, 387B, the first tape top regulating portions 381A, 382A, and the first ribbon top regulating portions 386A, 387A again keep the vertical positions of the film tape 59 and the ink ribbon 60 appropriately. Thus, the film tape 59 and the ink ribbon 60 can be fed appropriately and good printing quality can be maintained.

As described above, in the present embodiment, even when a force is applied to the arm portion 34 in the vertical direction of the tape cassette 30, due to an impact on the tape cassette 30, for example, the arm leading end portion 85 can return to the normal state.

When characters are printed on the film tape 59, the film tape 59 and the ink ribbon 60 that are discharged from the exit 341 are pressed against the thermal head 10 by the platen roller 15 (see FIG. 4). Then, the characters are printed on the film tape 59 by the thermal head 10 using the ink ribbon 60. Therefore, the film tape 59 needs to be appropriately discharged from the exit 341 in order to maintain the printing quality. For example, when an impact is applied to the tape cassette 30, generally, a gap may be created between the bottom case 312 and the top case 311 in the arm leading end portion 85, or the bottom case 312 and the top case 311 may be separated from each other. In such a case, the film tape 59 may not be appropriately discharged from the exit 341, and thus the printing quality may be deteriorated.

In the present embodiment, the top contact portion 86A and the bottom contact portion 86B are in contact with each other in the contact portion 86 in a state in which the top contact portion 86A and the bottom contact portion 86B can contact and separate from each other. Thus, when a strong impact or the like is applied to the tape cassette 30, as shown in FIG. 13, the top contact portion 86A and the bottom contact portion 86B are temporarily separated from each other. However, thereafter, the tape cassette 30 returns to the normal state in which the top contact portion 86A and the bottom contact portion 86B contact each other as shown in FIG. 10. Therefore, the film tape 59 and the ink ribbon 60 can be discharged from the exit 341 appropriately and the good printing quality can be maintained.

In the present embodiment, the latching portion 78 is provided in the semi-circular groove 38. The semi-circular groove 38 has a greater strength against bending than the arm front surface 35, which is a flat surface. Therefore, the top case 311 and the bottom case 312 can be engaged with each other with a greater strength than in the case in which the latching portion is provided in the arm front surface 35, in the vicinity of the exit 341. Consequently, when an impact is applied to the tape cassette 30, the latching hole 79 and the latching claw 80A are less likely to be disengaged from each other. Thus, the engagement between the top case 311 and the bottom case 312 can be maintained by the latching portion 78. Therefore, as shown in FIG. 13, even when the top contact portion 86A and the bottom contact portion 86B are separated from each other in the contact portion 86, the engagement between the top case 311 and the bottom case 312 can be maintained by the latching portion 78 so that the tape cassette 30 can return to the normal state shown in FIG. 10. In other words, a gap that has been created between the top case 311 and the bottom case 312 will not remain there. Therefore, the film tape 59 and the ink ribbon 60 can appropriately be discharged from the exit 341 so that the good printing quality can be maintained.

In the present embodiment, the top case 311 includes the protruding portion 89 and the bottom case 312 includes the leading end aperture 87. When the top case 311 and the bottom case 312 are joined with each other, the protruding portion 89 is inserted into the leading end aperture 87. Then, the top case 311 and the bottom case 312 can appropriately be guided in the arm leading end portion 85 by the protruding portion 89 and the leading end aperture 87. For that reason, when the top case 311 and the bottom case 312 are joined with each other, the top leading end portion 85A and the bottom leading end portion 85B can be prevented from inappropriately contacting the film tape 59 and the ink ribbon 60. Thus, the film tape 59 and the ink ribbon 60 may not get damaged and thus deterioration in the printing quality due to the damage can be prevented.

In the present embodiment, the height of the section of the top arm front surface 351 on the right side of the top leading end portion 85A is less than the height of the section of the bottom arm front surface 352 on the right side of the bottom leading end portion 85B (see FIG. 5). Thus, the top arm front surface 351 is more flexible than the bottom arm front surface 352. However, in the present embodiment, the contact portion 86 is provided in the vicinity of the center position of the cassette case 31 in the vertical direction. Thus, the top leading end portion 85A is higher than the section on the right side of the top leading end portion 85A. In other words, since the contact portion 86 is provided in the vicinity of the center position of the cassette case 31 in the vertical direction, the vertical length of the top leading end portion 85A can be prevented from being too short. Thus, if a force is applied to the arm leading end portion 85 in the vertical direction of the tape cassette 30, the top case 311 can be prevented from bending too much in the upward direction in the arm portion 34.

The tape cassette 30 and the tape printer 1 according to the present invention are not limited to the above embodiment and various modifications can be made.

For example, the entire peripheries of the top surface 301 and the bottom surface 302 in the cassette case 31 may not need to be entirely surrounded by side surfaces. An opening for exposing the inside of the cassette case 31 may be provided in part of the side surfaces (in the rear surface, for example) or a boss connecting the top surface 301 and the bottom surface 302 may be provided in the opening.

For example, the arm leading end portion 85 may not be provided with the protruding portion 89 and the leading end aperture 87. Even in this case, when an impact is applied to the tape cassette 30, the tape cassette 30 can return to the normal state after the top contact portion 86A and the bottom contact portion 86B are separated from each other in the contact portion 86.

The top case 311 includes the protruding portion 89 and the bottom case 312 includes the leading end aperture 87 in the embodiment. Alternatively, the top case 311 may include an aperture and the bottom case 312 may include a protruding portion that can be inserted into or removed from the aperture of the top case 311, for example.

The top case 311 includes the latching arm 80 and the bottom case 312 includes the latching hole 79 in the embodiment. Alternatively, the top case 311 may include a latching hole and the bottom case 312 may include a latching arm, for example.

The latching portion 78 is provided in the left portion of the semi-circular groove 38 in the embodiment. Alternatively, the latching portion 78 may be provided at the center of the semi-circular groove 38 in the right-and-left direction, for example.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A tape cassette, comprising:
a cassette case that has a top surface, a bottom surface, a front surface and a pair of side surfaces, and that includes a top case having the top surface and a bottom case having the bottom surface;
a tape as a print medium that is mounted within the cassette case;
an arm portion that includes a part of the front surface and directs the tape toward an exit along a portion of a predetermined feed path, the portion extending in parallel with the front surface;
a latching portion that is provided in the vicinity of an upstream end of the arm portion in a feeding direction of the tape and by which the top case and the bottom case are engaged with each other; and
a contact portion that is provided in the vicinity of the exit and that is configured to allow the top case and the bottom case to contact or separate from each other.

2. The tape cassette according to claim 1,
wherein the contact portion includes:
an aperture that is provided in one of the bottom case and the top case; and
a protruding portion that is provided in the other of the bottom case and the top case, and that can be inserted into or removed from the aperture.

3. The tape cassette according to claim 1,
wherein the latching portion includes:
an opening that is provided in the front surface of one of the bottom case and the top case, and that communicates an outside and an inside of the one of the bottom case and the top case; and
a latching piece that is provided in the other of the bottom case and the top case, and that has a protrusion that engages with the opening.

4. The tape cassette according to claim 3, further comprising an indented portion that is formed in the front surface adjacent to the upstream end of the arm portion, and that extends in a vertical direction of the cassette case,
wherein the latching portion is provided in the indented portion.

5. The tape cassette according to claim 1, wherein the contact portion is provided in the vicinity of a center position of the cassette case in the vertical direction.

6. The tape cassette according to claim 1, further comprising a bottom regulating portion that is provided on an upstream side of the exit in the feeding direction in a section of the bottom case that is included in the arm portion, and that is adapted to regulate a movement of the tape in a tape width direction.

7. The tape cassette according to claim 1, further comprising a top regulating portion that is provided on an upstream side of the exit in the feeding direction in a section of the top case that is included in the arm portion, and that is adapted to regulate a movement of the tape in a tape width direction.
